(19) United States
(12) Patent Application Publication
(10) Pub. No.: US 2006/0005661 A1
(43) Pub. Date: Jan. 12, 2006

(54) Power differential transfer device

(75) Inventor: Tohru Kagata, Toyota-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 11/158,361

(22) Filed: Jun. 22, 2005

(30) Foreign Application Priority Data
Jun. 25, 2004 (JP) 2004-187389

(51) Int. Cl. F16H 48/12

(52) U.S. Cl. 74/650

(57) ABSTRACT

Power differential transfer device for automatically changing the power transfer system to two wheel drive, four wheel drive or differential locking and includes a first cage disposed between a drive member and a first driven member for frictionally engaging with the first driven member for relative rotation and accommodating a first rolling member in an opening, a second cage provided between the drive member and a second driven member for frictionally engaging with the second driven member for relative rotation and accommodating a second rolling member in an opening. The first cage includes a projection for engaging with a recess provided in the second cage to allow a relative rotation by a limited angle.

This application is based on and claims priority under 35 U.S.C.§119 with respect to Japanese Application No. 2004-187389 filed on Jun. 25, 2004, the entire content of which is incorporated herein by reference.

### FIELD OF THE INVENTION

This invention generally relates to a power differential transfer device, and more particularly to a power differential transfer device having a differential function and the same or similar locking function to a differential gear device and capable of automatically changing from two wheel drive to four wheel drive or vise versa.

### BACKGROUND OF THE INVENTION

Known transfer device such as front differential device for ATV includes a power differential transfer device for changing drive mode among two wheel drive, four wheel drive and differential lock mode by manually operating or electrically controlling the clutch mechanism.

Among such known arts, a U.S. Pat. No. 6,896,085 B2 discloses a power switching apparatus having a power change over device for changing over the power distribution between drive member and two, right and left driven members. In this device, the a circumferential connecting surface of the drive member and respective circumferential connecting surfaces of the two driven members are wedge connected through rollers by rotating the edge surface of the cage which is forcibly moved in axial direction by an electromagnetic force so as to be in friction contact with the driven members when the change over means is set at on-mode. According to this simple construction, the change over between full two wheel drive and full four-wheel drive modes can be easily performed.

### SUMMARY OF THE INVENTION

According to one aspect of the invention, a power differential transfer device includes a drive member having an inner cam face, a first driven member disposed coaxially with the drive member at an inside of the drive member and having a first outer cam face at an outer peripheral surface, a second driven member disposed coaxially with the drive member at the inside of the drive member and being adjacent to the first driven member in an axial direction, the second driven member having a second outer cam face at the outer peripheral surface, a plurality of first rolling members disposed in an annular space formed by a plurality of wedge shaped spaces between the inner cam face and the first outer cam face in a circumferential direction for wedge connection between the drive member and the first driven member, a plurality of second rolling members disposed in an annular space formed by a plurality of wedge shaped spaces between the inner cam face and the second outer cam face in a circumferential direction for wedge connection between the drive member and the second driven member, a first cage frictionally engaging with the first driven member directly or indirectly for permitting relative rotation therewith and having a plurality of first openings for accommodating the plurality of first rolling members respectively therein; and a second cage frictionally engaging with the second driven member directly or indirectly for permitting relative rotation therewith and having a plurality of second openings for accommodating the plurality of second rolling members respectively therein.

The power differential transfer device of the invention includes a feature that the first cage includes a projection extending to the second cage side, the second cage includes a recess for receiving the projection of the first cage and that the projection of the first cage and the recess of the second cage allow a relative rotation therebetween by a predetermined angle. The predetermined angle is defined by an angle between a first line connecting a rotation axis of the drive member and the center of one of the plurality of first rolling member at a wedge connection position and a second line between the rotation axis of the drive member and one of the plurality of center of the second rolling member at a non-wedge connection position within the wedged space where the first rolling member is situated, or an angle between a third line connecting the rotation axis of the drive member and the center of the second rolling member at the wedge connection position and a fourth line connecting the rotation axis of the drive member and the center of the first rolling member at the non-wedge connection position within the wedge space where the second rolling member is situated.

According to another aspect of the present invention, the power differential transfer device includes a drive member having a circumferential connection surface in an inner peripheral surface, a first driven member disposed coaxially with the drive member in the inner periphery side of the drive member and having an inner cam face at an outer peripheral surface of the first driven member, a second driven member disposed coaxially with the drive member at the inner peripheral side of the drive member and disposed adjacent the first driven member in an axial direction, the second driven member having an inner cam face at an outer peripheral surface of the second driven member, a first rolling member disposed in an annular space formed by a plurality of wedge shaped spaces between the drive member and the first driven member in a circumferential direction for wedge connection between the drive member and the first driven member, a second rolling member disposed in an annular space formed by a plurality of wedge shaped spaces between the drive member and the first driven member in a circumferential direction for wedge connection between the drive member and the second driven member, a first cage frictionally engaging with the first driven member for relative rotation therewith directly or indirectly and having an opening for accommodating the first rolling member therein and a second cage member frictionally engaging with the second driven member for relative rotation therewith directly or indirectly and having an opening for accommodating the second rolling member therein. The feature of this structure according to the aspect of the invention is that the first cage includes a projection extending to the second cage side, the second cage includes a recess for receiving the projection of the first cage and that the projection of the first cage and the recess of the second cage allow a relative rotation therebetween by a predetermined angle. This predetermined angle is defined by an angle between a first line connecting a rotation axis of the drive member and the center of the first rolling member at a wedge connection position and a second line between the rotation axis of the drive member and the center of the second rolling member at a non-wedge connection position within the wedged space where the first rolling member is situated, or an angle between a third line connecting the rotation axis of the drive member and the center of the second rolling member at the wedge connection position and a fourth line connecting the rotation axis of the drive member and the center of the first rolling member at the non-wedge connection position within the wedge space where the second rolling member is situated.

The wedged space means a space formed in wedge shape between an outer surface of the drive member and the outer surface of the first and the second driven members seen in an axial direction. In other words, the space between the surfaces of the drive member and the driven members is formed from the smallest to the largest with a wedge shape.

The wedge connection means a connection between the drive member and the driven members by the rolling member which rolls from the larger space in wedge space to the smaller space to engage the drive member and the driven member by wedge action.

### BRIEF DESCRIPTION OF THE DRAWING FIGURES

The foregoing and additional features and characteristics of the present invention will become more apparent from the following detailed description considered with reference to the accompanying drawing figures in which like reference numerals designate like elements and wherein:

FIG. 1 is a schematic view of a vehicle with a power differential transfer device according to a first embodiment of the present invention;

FIG. 2 is a cross sectional view of the power differential transfer device according to the first embodiment of the invention, but only showing schematically;

FIG. 3 is a cross sectional view of the power differential transfer device according to the first embodiment of the invention taken along A-A line of FIG. 2;

FIG. 4 is a schematic view of a first cage and a second cage used in the power differential transfer device of the first embodiment of the invention, showing a plane view, left side view and right side view for each cage;

FIG. 5 is a schematic view of a first spring used in the power differential transfer device of the first embodiment of the invention, showing a plane view and a side view;

FIG. 6 is a view explaining operations of the first cage and the second cage used in the power differential transfer device of the first embodiment of the invention, showing a state of neutral position of the first and second cages;

FIG. 7 is a view explaining operations of the first cage and the second cage used in the power differential transfer device of the aspect of the invention, each showing a state of vehicle straight forward running;

FIG. 8 is a view similar to FIG. 7, but explaining operations of the first cage and the second cage used in the power differential transfer device of the first embodiment of the invention, each showing a state of vehicle forward running with left turning;

FIG. 9 is a view explaining operations of the first cage and the second cage used in the power differential transfer device of the first embodiment of the invention, each showing a state of vehicle rearward straight running;

FIG. 10 is a view explaining operations of the first cage and the second cage used in the power differential transfer device of the aspect of the invention, each showing a state of vehicle straight forward running with engine braking; and,

FIG. 11 is a schematic view explaining a predetermined permissible angle of relative rotation between the first cage and the second cage used in the power differential transfer device of the first embodiment of the invention.

### DETAILED DESCRIPTION OF THE INVENTION

A first embodiment of the present invention is explained hereinafter referring to attached drawings.

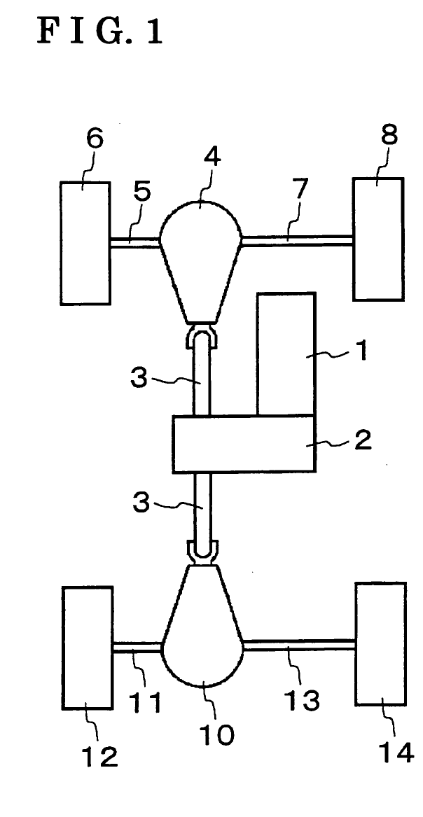

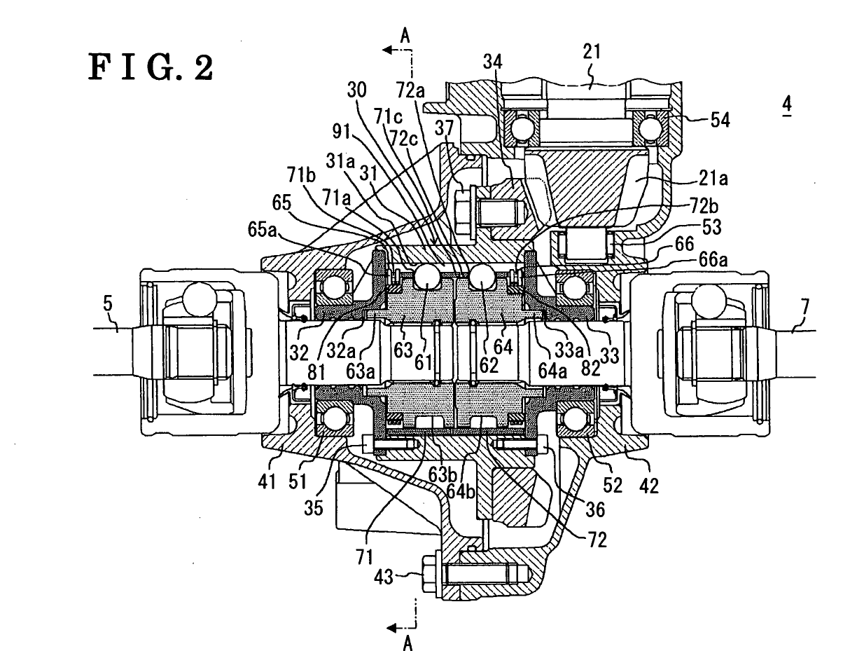

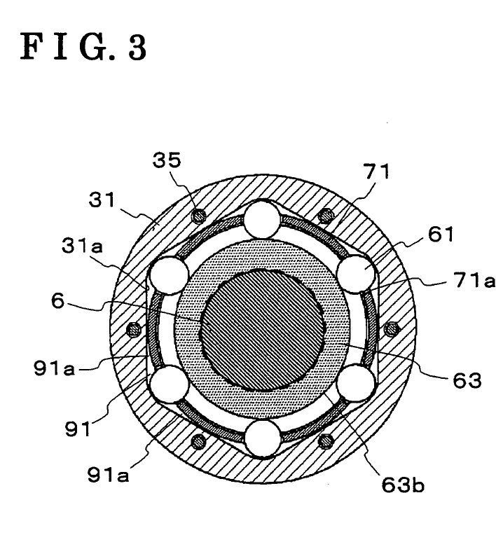

FIG. 1 is a schematic view of a vehicle with a power differential transfer device according to the first embodiment of the present invention. FIG. 2 is a cross sectional view of the power differential transfer device, but only showing schematically. FIG. 3 is a cross sectional view of the power differential transfer device according to the embodiment of the invention taken along A-A line of FIG. 2.

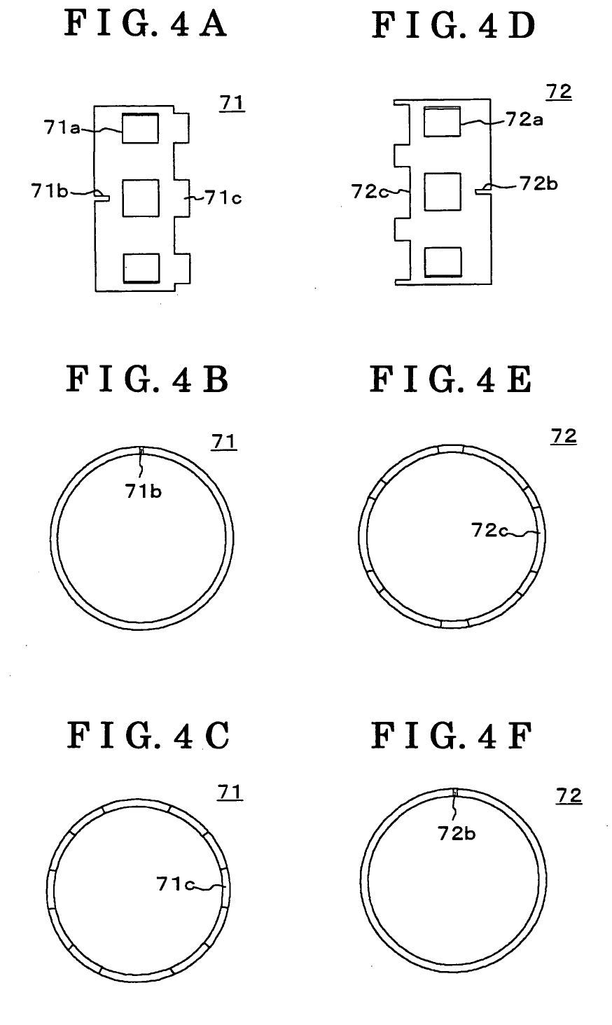

FIG. 4 is a schematic view of a first cage and a second cage used in the power differential transfer device of the embodiment of the invention, each showing a plane view, left side view and right side view. FIG. 4 shows various views of the cages according to the embodiment, in which FIG. 4 (A) shows a plane view of the first cage 71, (B) shows a left side view of the first cage, (C) shows a right side view of the first cage, (D) shows a plane view of the second cage 72, (E) shows a left side view of the second cage and (F) shows a right side view of the second cage.

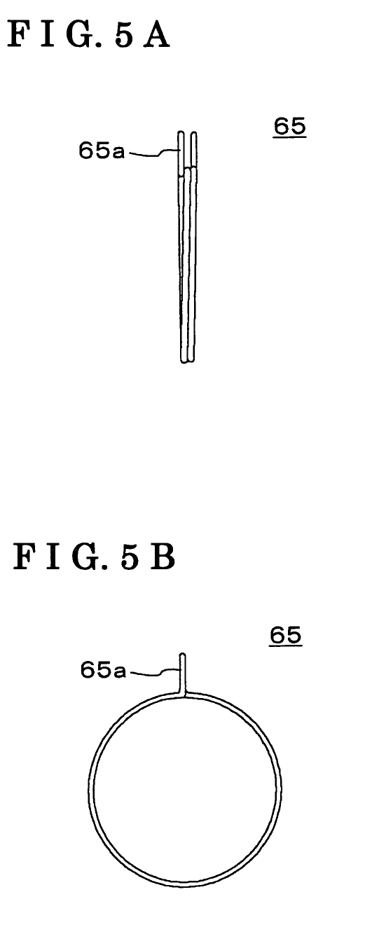

FIG. 5 is a schematic view of a first spring 65 used in the power differential transfer device of the embodiment of the invention, showing a plane view and a side view. FIG. 5 (A) shows a plane view of the first spring and Fig. (B) shows a side view of the first spring of this embodiment. In FIG. 3, the first housing and the second housing are omitted from the drawing for more easily understanding the spring.

First the vehicle as a whole will be explained in accordance with FIG. 1. A vehicle includes an engine 1, a transmission 2 connected to the output side of the engine 1, a drive shaft 3 connected to the output side of the transmission 2, a power differential transfer device 4 connected at the front end of the drive shaft 3. The vehicle further includes a front left side wheel 6 connected to one end of a front wheel shaft 5. The other end of the shaft 5 is connected to the power differential transfer device 4. A front right side wheel 8 is connected to one end of a right side front wheel shaft 7. The other end of the shaft 7 is connected to the power differential transfer device 4. A differential gear unit 10 is connected to the rear end of the drive shaft 3. A rear left side wheel 12 is connected to one end of a rear wheel shaft 11. The other end of the rear wheel shaft 11 is connected to the differential gear unit 10 and a rear right side wheel 14 is connected to one end of another (right side) rear wheel shaft 13. The other end of the shaft 13 is connected to the differential gear unit 10.

Rotational torque from the engine 1 is always transmitted to the differential gear unit 10 at the rear side wheels 12 and 14 and also always transmitted to the power differential transfer device 4 at the front side wheels 6 and 8. The power differential transfer device 4 transmits the engine torque through four routes, (A) to right and left side wheel shafts 7, 5, (B) to only right side wheel shaft 7, (C) to only left side wheel shaft 5 and (D) not to transmit the engine torque to both front right and left side wheel shafts 7, 5 by switching operation based on the road surface conditions detected through left side front wheel 6 and left side wheel shaft 5 and through right side front wheel 8 and right side wheel shaft 7 by only mechanical operation, without any manual or electrical controlling. This will be later explained in detail.

The power differential transfer device 4 will be explained hereinafter. In FIG. 2, the power differential transfer device 4 includes a pinion gear shaft 21, a drive member 30, a first housing 41, a second housing 42, bolt 43, bearings 51, 52, 53 and 54, a first rolling member 61, a second rolling member 62, a first driven member 63, a second driven member 64, a first spring 65, a second spring 66, a first cage 71, a second cage 72, a first friction member 81 and a second friction member 82.

The pinion gear shaft 21 is rotatably supported on the second housing 42 through the bearings 53 and 54. The pinion gear shaft 21 includes a pinion gear 21a between a portion supported by the bearing 53 and a portion supported by the bearing 54. The pinion gear 21a engages with a ring gear 34. The pinion gear shaft 21 is connected to the drive shaft 3 (shown in FIG. 1).

The drive member 30 is an assembly of a case 31, a first cover 32 and a second cover 33, the ring gear 34, screws 35 and 36 for connecting the first and the second covers 32 and 33 to the case 31 and a bolt 37 for connecting the ring gear 34 to the case 31. These components 31 to 37 are rotated as a unit. The drive member 30 is rotatably supported by the first and second housings 41 and 42 through the bearings 51 and 52. The bearing 51 is supported by the first housing 41 and the bearing 52 is supported by the second housing 42.

The case 31 is a cylindrical member having a plurality of inner cam faces 31a at the inner peripheral surface thereof. The inner cam faces 31a form a polygon. Inside of the case 31, a plurality of first and second rolling members 61 and 62 are provided, the number of which corresponds to the number of the inner cam face, i.e., the number of the side of the polygon, for example, if the polygon is a hexagon, then the number of the rolling member 61 and 62 is 12 in total (6+6). The first cover 32 is connected to the left side end of the case 31 by the screw 35, while the second cover 33 is connected to the right side end of the case 31 by the screw 36. The first cover 32 is supported by the first housing 41 through the first bearing 51. The second cover 33 is supported by the second housing 42 through the second bearing 52. The ring gear 34 is attached to the outer peripheral portion of the case 31 by the bolt 37 and is engaged with the pinion gear 21a. Thus the drive member 30 is always driven by the rotation of the drive shaft 3 shown in FIG. 1.

The first housing 41 and the second housing 42 are integrally connected together by the bolt 43.

The first driven member 63 is provided at inner peripheral side of the case 31 to the first cover 31. The first driven member 63 is in spline connection with the front left wheel shaft 5 and rotated together with the wheel shaft 5. The second driven member 64 is provided at the inside of the case 31 to the second cover 33. The second driven member 64 is in spline connection with the front right wheel shaft 7 and rotated together with the wheel shaft 7. The first and second driven members 63 and 64 are coaxially provided with the center axis of the drive member 30. The first driven member 63 is provided with a hub portion 63a at the first cover 32 side. The hub portion 63a is relatively rotatably inserted into a stepped portion 32a provided at the inner peripheral portion of the first cover 32 at left side thereof. The second driven member 64 is provided with a hub portion 64a at the second cover 33 side. The hub portion 64a is relatively rotatably inserted into a stepped portion 33a provided at the inner peripheral portion of the second cover 33 at left side thereof. Thus the first and second driven members 63 and 64 are held to the drive member 30 for relative rotation with the drive member 30 (case 31, first cover 32 and second cover 33). The drive member 30 (case 31 and ring gear 34) and the first and second driven members 63 and 64 are coaxially provided. A spacer (not shown) may be provided between the first and second driven members 63 and 64 for keeping the space therebetween.

The first driven member 63 is provided with a first outer cam face 63b, which is in contact with the first rolling member 61 at the outer peripheral surface of the first driven member 63. Similarly, the second driven member 64 is provided with a second outer cam face 64b, which is in contact with the second rolling member 62 at the outer peripheral surface of the second driven member 64. The outer cam face 63b of the first driven member 63 and the outer cam face 64b of the second driven member 64b are provided coaxially with the case 31 (cam faces 31a). In an annular space 91 provided among the outer cam face 63b of the first driven member 63 and the outer cam face 64b of the second driven member 64b and the inner cam faces 31a, a plurality of wedged space 91a (FIG. 3) are formed, which gradually become narrower toward both peripheral directions (both rotation directions).

The first rolling member 61 is spherical in shape and accommodated in an opening 71a provided at the first cage 71 in the annular space 91. The first rolling member 61 contacts with the inner cam face 31a of the case 31 and contacts with the circumferential connection portion 63b of the first driven member 63 at the opposite side. The first cage 71 restricts the movement of the circumferential connection portion 63b in rotational and axial directions. Similarly, the second rolling member 62 is spherical in shape and accommodated in an opening 72a provided at the second cage 72 in the annular space 91. The second rolling member 62 contacts with the inner cam face 31a of the case 31 and contacts with the circumferential connection portion 64b of the second driven member 64 at the opposite side. The second cage 72 restricts the movement of the circumferential connection portion 64b in rotational and axial directions. The shape of the first and second rolling members 61 and 62 may not be limited to the spherical shape but may be a roller.

The first cage 71 is a cylindrical member and provided in the annular space 91 at the first cover 32 side. (See FIG. 2 and FIG. 4.). The first cage 71 includes a recess 71b at the first cover 32 side for inserting a pawl 65a provided at the first spring 65. The second cage 72 is a cylindrical member and provided in the annular space 91 at the second cover 33 side. (see FIG. 2 and FIG. 4). The second cage 72 includes a recess 72b at the second cover 33 side for inserting a pawl 66a provided at the second spring 66.

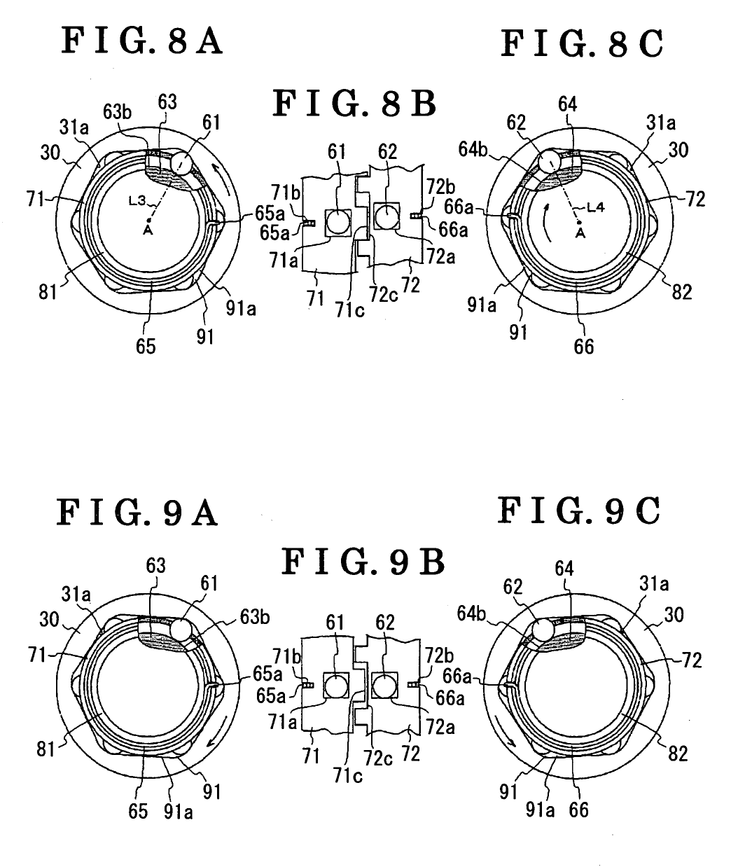

The first cage 71 includes a projection 71c extending toward the second cage 72 side. The second cage 72 includes a recess 72c provided at a position capable of engaging with the projection 71c of the first cage 71. The projection 71c and the recess 72c permit a predetermined relative rotation. This permitted relative rotation is determined to half of the angle formed between a first line L1 connecting the rotation axis of the drive member 30 and the center of the first rolling member 61 at the engaging position in vehicle forward driving and a second line L2 connecting the rotation axis of the drive member 30 and the center of the first rolling member 61 at the engaging position in vehicle rearward driving. In other words, as shown in FIG. 8 or FIG. 11, such angle is defined by an angle α formed between a third line L3 connecting the rotation axis A of the drive member 30 when the vehicle is turning to the left in forward direction (see FIG. 8 (A)) and a fourth line L4 connecting the rotation axis A of the drive member 30 and the center of second rolling member 62 at a position in the annular space 91a equivalent to the first rolling member 61, where no wedge connection is made when the vehicle is turning to left in forward direction (see FIG. 8 (C)). The angle [symbol] is also defined by a fifth line connecting the rotation axis of the drive member 30 and the center of second rolling member 62 at a position in the annular space 91a equivalent to the second rolling member 62, where wedge connection is made when the vehicle is turning to right in forward direction and a sixth line connecting the rotation axis of the drive member 30 and the center of the first rolling member 61 at a position in the annular space 91a, where no wedge connection is made when the vehicle is turning to right in forward direction. (See FIG. 8 and FIG. 11). FIG. 11 shows mainly the first cage seen from the left side thereof.

The first spring 65 is of ring type wound around the outer periphery of the first friction member 81 and internally in contact with the outer periphery of the first friction member 81 under slidable rotation therewith for frictional rotation by the elastic force. (See FIG. 2 and FIG. 5). Similarly, the second spring 66 is of ring type wound around the outer periphery of the second friction member 82 and internally in contact with the outer periphery of the second friction member 82 under slidable rotation therewith for frictional rotation by the elastic force. The first spring 65 includes a pawl portion 65a, which is engaged with the recess portion 71b of the first cage 71. The second spring 66 includes a pawl portion 66a, which is engaged with the recess portion 71b of the first cage 71.

The first cage 71 frictionally engages with the first driven member 63 having the outer cam face 63b through the first friction member 81 and the first spring 65 for relative rotation and is rotated by the rotation of the first driven member 63. Similarly, the second cage 72 frictionally engages with the second driven member 64 having the outer cam face 64b through the second friction member 82 and the second spring 66 for relative rotation and is rotated by the rotation of the second driven member 64. In other words, the first and second cages 71 and 72 are not frictionally engaged with the drive member 30 (case 31) both directly and indirectly. Thus the cages 71 and 72 are not rotated with the drive member 30.

The first friction member 81 is fixed to an area on the outer periphery surface other than the outer cam face 63b at the first cover 32 side. The first friction member 81 is frictionally engaged with the first spring 65 for relative rotation therewith. The first friction member 81 is fixed to an area on the outer periphery surface other than the outer cam face 63b at the first cover 32 side. The second friction member 82 is frictionally engaged with the second spring 66 for relative rotation therewith.

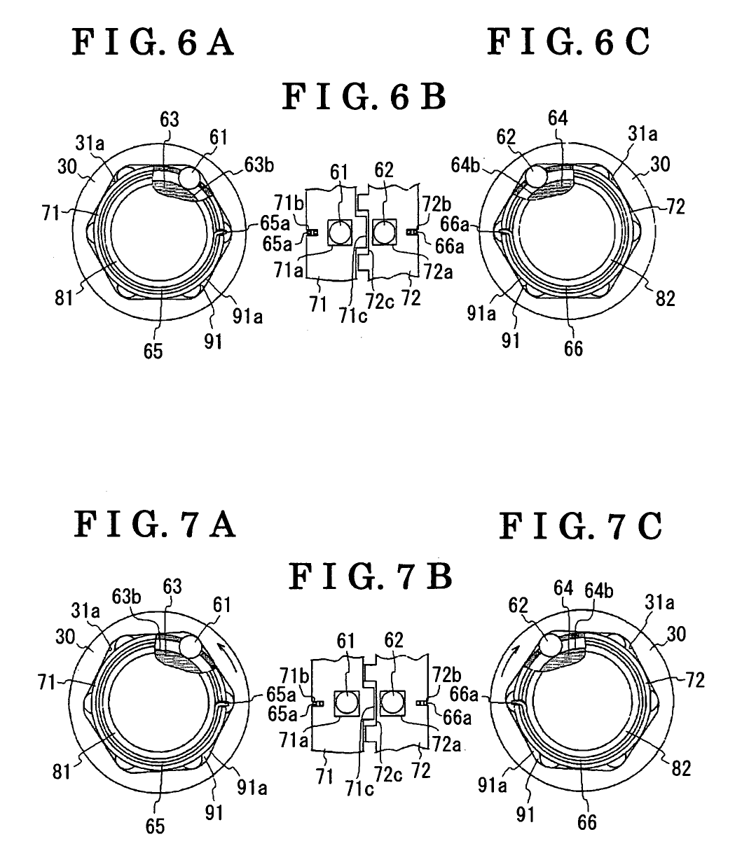

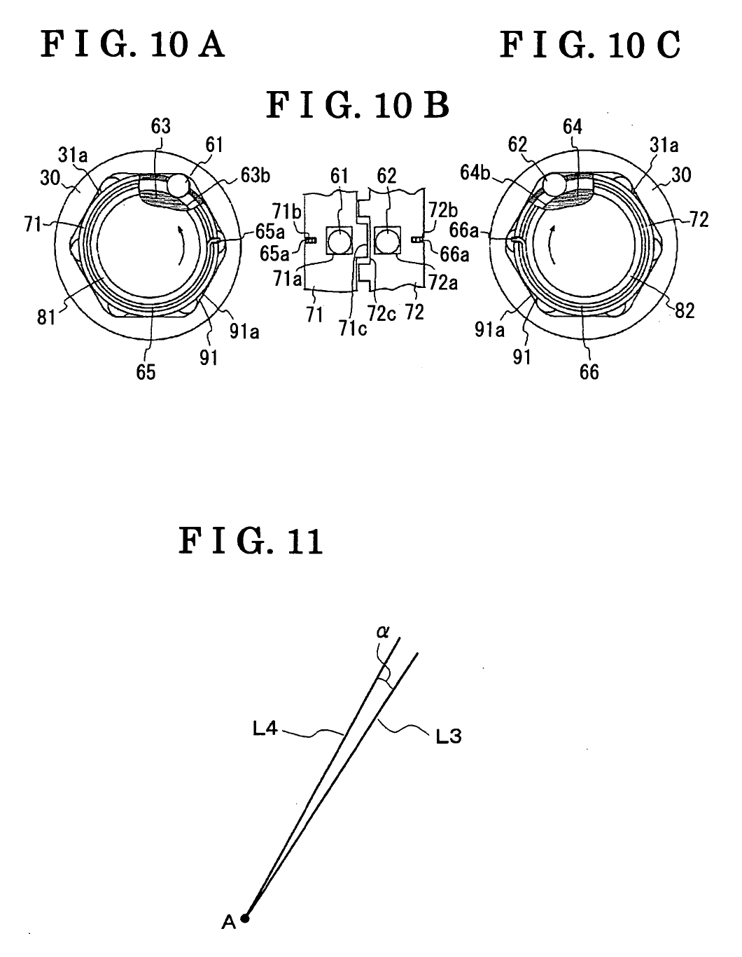

The operation of the first embodiment of the invention will be explained with the attached drawings. FIGS. 6 through 10 explain the operation of the first and second cages used in the power differential transfer device, wherein each (A) shows a partial side view of the first cage seen from the left side, (B) shows a partial plane view of the first and second cages and (C) shows a partial side view of the second cage seen from the right side. FIG. 6 shows a neutral position and FIG. 7 shows a vehicle forward straight running condition, FIG. 8 shows a vehicle left turning condition in vehicle forward running, FIG. 9 shows a vehicle rearward straight running condition and FIG. 10 shows a vehicle forward straight running under engine braking.

In FIG. 6 (neutral position), when the rotational speed (rpm) between the engine side (drive member 30 side) and the tire side (driven members 63 and 64 side) has no rotational speed difference, the drive member 30, the first driven member 63 and the second driven member 64 are not rotated and accordingly, the first and second rolling members 61 and 62 are positioned in the annular space 91 at the area where the distance of the inner cam face 31a from the outer surface of the circumferential connection surfaces 63b and 64b is the largest and both first and second driven members 63 and 64 are not wedge connected with the drive member 30.

In FIG. 7 (vehicle forward straight running), when the vehicle is going straight ahead and the engine rpm is higher than that of the front wheels due to, for example, a wheel slipping, a difference in rotation speed between the drive member 30 and the first and second driven members 63 and 64 occurs. Due to this difference, the drive member 30 and the driven members 63 and 64 are immediately in wedge connected. Then the drive torque from the drive member 30 is transmitted to the first and second driven members 63 and 64. Then the vehicle drive system becomes the four-wheel drive condition. The first and second rolling members 61 and 62 are forced to move in a normal rotational direction of the drive member 30 by the inner cam face 31a of the drive member 30. The first rolling member 61 becomes in contact with the edge of the opening 71a of the first cage 71 in a normal rotational direction. Since the first and second driven members 63 and 64 are wedge connected with the drive member 30 by the first and second rolling members 61 and 62, the torque transmitted to the first and second driven members 63 and 64 become equal which assures the stability in straight forward running.

In FIG. 8 (left turning in forward running), when the vehicle is running forward and making a left turn, and if the engine rpm is higher than that of wheel side, a rotational difference between the drive member 30 and the left side first driven member 63 occurs. The drive member 30 and the first driven member 63 are immediately wedge connected by the first rolling member 61 and then the torque is transmitted to the first driven member 63. The first rolling member 61 is forced to move in a normal rotational direction of the drive member by the cam action of the inner cam face 31a provided at the drive member 30. The first rolling member 61 becomes in contact with the edge of the opening 71a of the first cage 71 in a normal rotational direction. The first cage 71 is then forced to move in a normal rotational direction by the first rolling member 61. On the other hand, since the rotational speed of the second driven member 64 at the right side is higher than that of the first driven member 63 at the right side due to over-run of the front right wheel, the recess 72c of the second cage 72 is engaged with the projection 71c of the first cage 71. A slip is generated between the second spring 66 and the second friction member 82 to generate rotation difference between the second cage 72 and the second driven member 64. The second rolling member 62 is engaged with the second cage 72 not to wedge connect the drive member 30 and the second driven member 64. Thus the torque will not be transmitted to the second driven member 64 to assuredly perform the differential function.

The attached drawings do not show the condition of vehicle left turn driving, but in this condition, the rotational difference is generated between the drive member 30 and the second driven member at the right side and the drive member 30 and the second driven member 64 are immediately wedge connected by the second rolling member 62 to transmit the torque to the second driven member 64. The second rolling member 62 is forced to move in the rotational direction of the drive member 30 by the cam action of the inner cam face 31a provided at the drive member 30. The second rolling member 62 becomes in contact with the edge of the opening 72a of the second cage 72 in a normal rotational direction. The second cage 72 is then forced to move in a normal rotational direction by the second rolling member 62. On the other hand, since the rotational speed of the first driven member 63 at the left side is higher than that of the second driven member 64 at the right side due to over-run of the front left wheel, the recess 72c of the second cage 72 is engaged with the projection 71c of the first cage 71. A slip is generated between the first spring 65 and the first friction member 81 to generate rotation difference between the first cage 71 and the first driven member 63. The first rolling member 61 is engaged with the first cage 72 not to wedge connect the drive member 30 and the first driven member 63. Thus the torque will not be transmitted to the second driven member 64 to assuredly perform the differential function.

In FIG. 9 (rearward straight running), when the vehicle is running straight rearward and the engine side rpm is higher than that of the wheel side, a rotational difference is generated between the drive member 30 and the first and second driven members 63 and 64. Then the drive member 30 and the first and second driven members 63 and 64 are immediately wedge connected to transmit the torque to the first and second driven members 63 and 64. The vehicle becomes an engine braking running condition. The first and second rolling members 61 and 62 are forced to move in a reverse rotational direction of the drive member 30 by the cam action of the inner cam face 31a provided at the drive member 30. The first rolling member 61 becomes in contact with the edge of the opening 71a of the first cage 71 in a reverse rotational direction and at the same time the second rolling member 62 becomes in contact with the edge of the opening 72a of the second cage 72 in a reverse rotational direction. The first and the second driven members 63 and 64 are wedge connected with the drive member 30 by the first and the second rolling members 61 and 62. Thus the torque transmitted to the first and the second driven members 63 and 64 is equal. Accordingly, the vehicle can run stable in forward straight running.

According to the first embodiment of this invention, even under the four wheel driving condition, the relative rotational displacement of the first cage 71 and the second cage 72 holding the first and the second rolling members 61 and 62 in a rotational direction can be permitted to a predetermined proper amount in order not to reduce the differential function. Further wedge connection with the inner cam face in the other direction, which may occur by the outer wheel over-run at the vehicle turning motion can be eliminated to keep the first rolling member 61 (or the second rolling member 62) which corresponds to the outer wheels under the vehicle turning motion to non-driving position. This will assuredly enable the differential function.

Further, when the rotational difference is generated between the first and second driven members 63 and 64 and the drive member 30, the first and second driven members 63 and 64 and the drive member 30 are immediately wedge connected by the first and the second rolling members 61 and 62. (ball clutch mechanism) The engagement and disengagement of the drive member 30 with the first and the second driven members 63 and 64 can be easily and lightly to be performed.

Further, the power differential transfer device does not house the differential gear unit and accordingly the device is simple, compact in structure and lightweight.

Next a modification of the first embodiment will be explained hereinafter. In this modification, the first and the second driven members include cam face and the drive member (case) includes a circumferential connection surface instead of providing the circumferential connection surface (63b) at the first and the second driven members and providing the inner cam face (31a) at the drive member 30 (case 31). In other words, the frictional slidable connection between the first cage and the first driven member is performed at the circumferential connection surface between the case and the first rolling member and cam action is performed at the contact surface between the first driven member and the first rolling member. Similarly, the frictional slidable connection between the second cage and the second driven member is performed at the circumferential connection surface between the drive member (case) and the second rolling member and cam action is performed at the contact surface between the second driven member and the second rolling member. In this case, the first and the second cages are frictionally engaged with the drive member (case) directly or indirectly for relative rotation to rotate the drive member (case) as a unit. In other words, the first cage and the second cage having cam faces are not frictionally engaged, neither directly nor indirectly. Thus the first and the second driven members are not rotated with the first and the second cages. This modification can perform the same function and the same results can be obtained.

What is claimed is:

1. A power differential transfer device comprising:
a drive member having an inner cam face at a inner peripheral surface;
a first driven member disposed coaxially at an inside of the drive member and having a first outer cam face at an outer peripheral surface;
a second driven member disposed coaxially at an inside of the drive member and being adjacent to the first driven member in an axial direction, the second driven member having a second outer cam face at an outer peripheral surface;
a plurality of first rolling members disposed in an annular space formed by a plurality of first wedge shaped spaces between the inner cam face and the first outer cam face for wedge connection between the drive member and the first driven member;
a plurality of second rolling members disposed in an annular space formed by a plurality of second wedge shaped spaces between the inner cam face and the second outer cam face for wedge connection between the drive member and the second driven member;
a first cage frictionally engaging with the first driven member directly or indirectly for permitting relative rotation therewith and having a plurality of first openings for accommodating the plurality of first rolling members respectively therein; and
a second cage frictionally engaging with the second driven member directly or indirectly for permitting relative rotation therewith and having a plurality of second openings for accommodating the plurality of second rolling members respectively therein.

2. A power differential transfer device according to claim 1, wherein the first cage includes a projection extending to the second cage side, the second cage includes a recess for receiving the projection of the first cage, the projection of the first cage and the recess of the second cage allow a relative rotation therebetween by a predetermined angle and the predetermined angle is defined by an angle between a first line connecting a rotation axis of the drive member and the center of one of the plurality of first rolling member at a wedge connection position and a second line between the rotation axis of the drive member and the center of one of the plurality of second rolling members at a non-wedge connection position within one of the plurality of wedged space equivalent to the first rolling member.

3. A power differential transfer device according to claim 1, wherein the first cage and the first driven member are frictionally engaged via a first frictional member by a force of a first spring and the second cage and the second driven member are frictionally engaged via a second frictional member by a force of a second spring.

4. A power differential transfer device according to claim 2, wherein the first cage and the first driven member are frictionally engaged via a first frictional member by a force of a first spring and the second cage and the second driven member are frictionally engaged via a second frictional member by a force of a second spring.

5. A power differential transfer device according to claim 4, wherein the first spring and the second spring are of ring shape and pawl portions are provided at both ends of the first and second springs, the pawl portions are hooked at the recess of either the first cage or the second cage, each of the first and the second springs has a wound portion for forcing the first or second friction member against the first or the second driven member.

6. A power differential transfer device according to claim 5, wherein the first spring and the second spring are of ring shape and pawl portions are provided at both ends of the first and second springs, the pawl portions are hooked at the recess of either the first cage or the second cage, each of the first and the second springs has a wound portion for forcing the first or second friction member against the first or the second driven member.

7. A power differential transfer device according to claim 1, wherein the first and the second rolling members are of spherical shape.

8. A power differential transfer device according to claim 3, wherein the first and the second rolling members are of spherical shape.

9. A power differential transfer device according to claim 4, wherein the first and the second rolling members are of spherical shape.

10. A power differential transfer device according to claim 1, wherein the first and the second rolling members are of roller shape.

11. A power differential transfer device according to claim 3, wherein the first and the second rolling members are of roller shape.

12. A power differential transfer device according to claim 4, wherein the first and the second rolling members are of roller shape.

13. A power differential transfer device according to claim 1, wherein the first and the second driven members are connected to vehicle wheels.

14. A power differential transfer device according to claim 2, wherein the first and the second driven members are connected to vehicle wheels.

15. A power differential transfer device according to claim 13, wherein the drive member is provided with a ring gear and connected to a pinion gear shaft via the ring gear.

16. A power differential transfer device according to claim 14, wherein the drive member is provided with a ring gear and connected to a pinion gear shaft via the ring gear.
